(19) United States
(12) Patent Application Publication
(10) Pub. No.: US 2026/0091485 A1
(43) Pub. Date: Apr. 2, 2026

(54) APPARATUS FOR HANDLING NAPKINS AND METHOD FOR HANDLING NAPKINS

(71) Applicant: Herbert Kannegiesser GmbH, Vlotho (DE)

(72) Inventor: Engelbert HEINZ, Vlotho (DE)

(73) Assignee: Herbert Kannegiesser GmbH, Vlotho (DE)

(21) Appl. No.: 19/347,326

(22) Filed: Oct. 1, 2025

(30) Foreign Application Priority Data
Oct. 2, 2024 (DE) 10 2024 128 489.7

(51) Int. Cl. B25J 9/00; B25J 5/02; B25J 9/16; B25J 15/00

(52) U.S. Cl. CPC B25J 9/0093; B25J 5/02; B25J 9/1697; B25J 15/0052

(57) ABSTRACT

An apparatus and a method for handling napkins, by means of which the handling process can be made more efficient in terms of time and less expensive. This is achieved by virtue of the fact that at least one of the napkins, in particular a stack of napkins, hangs in each case over one of a number of mutually adjacent beams of a deposition device, in particular in such a way that the napkin is deposited by means of a central region, preferably by means of a center, over a beam. One significant feature consists in that, by means of at least one multi-axis robot, which has at least two gripping elements, the gripping elements can be moved in a fully automated and selective manner up to the at least one napkin, and the at least one napkin is deposited on a transport means.

The invention relates to an apparatus for handling napkins in accordance with the preamble of claim 1. The invention furthermore relates to a method for handling napkins in accordance with the preamble of claim 11.

Napkins, in particular table napkins, are used in large quantities in gastronomy and the hotel trade. To handle these large quantities of napkins in commercial laundries, the individual napkins are deposited over beams in what are referred to as deposition machines or deposition devices. First of all, the napkins pass through a corresponding washing process and are fed along several tracks, via input machines, to mangles. After the mangles, the individual napkins are hung over the beams manually or automatically, i.e. by machine. Over each beam, it is possible to hang one napkin or a multiplicity of napkins one on top of the other to form a stack, more specifically in such a way that the individual napkins are deposited by means of their center or a central region over the beams, such that the hanging halves of the napkin hang next to one another in an at least approximately congruent manner. In this way, it is possible to deposit 10, 20 or 30 to 50 napkins into stacks. Here, the beams can have a round, a rectangular or a polygonal cross section and correspond in length at least to a width of the napkin. In general, the beams are slightly longer than the width of the napkins.

As soon as one beam has been loaded with a predetermined number of napkins, a subsequent beam is loaded with napkins in the same way. It is conceivable here that the individual beams are assigned in parallel to a conveying element and are rotated further in steps, e.g. in a drum or revolver drum. There is a known practice according to which a multiplicity of such beams is arranged in succession or else side by side, thus enabling the deposition devices or a plurality of beams to be loaded simultaneously in parallel in the deposition device.

For further handling of the napkins, it is known that individual napkins or a napkin stack are removed manually from the beams by human personnel and deposited on a transport means, e.g. a conveyor belt. This manual handling proves to be necessary since grabbing and transferring the stacks of napkins requires high flexibility and dexterity. However, the use of human personnel proves to be very inefficient in terms of time and expensive, given the large number of napkins to be handled.

The problem underlying the invention is that of providing an apparatus and a method for handling napkins, by means of which the process described can be made more efficient in terms of time and less expensive.

An apparatus for solving the stated problem has the features of claim 1. According to this, it is envisaged that at least one napkin, preferably a multiplicity of napkins, in particular a stack of napkins, hangs in each case over one of a number of mutually adjacent beams of a deposition device, in particular in such a way that the napkin is deposited by means of a central region, preferably by means of a center, over a beam. One significant feature of the invention consists in that, by means of at least one multi-axis robot, which has at least two gripping elements, the gripping elements can be moved in a fully automated and selective manner up to the at least one napkin, and the at least one napkin is deposited on a transport means. The use of a multi-axis robot with gripping elements makes it possible to fully automate the transfer of the napkins from the deposition device to the transport means for further processing, as a result of which the entire handling of the napkins can be made very efficient in terms of time and furthermore is economical.

The multi-axis robot can be programmed in such a way that it approaches, grabs, repositions, deposits and releases individual napkins or the hanging stacks of napkins selectively and with the necessary accuracy and reliability. In particular, the high cycle rate with which the robot can carry out the abovementioned process leads to an improvement of the known systems which is very efficient in terms of time.

Provision is furthermore preferably made for the gripping elements each to have a clamp pair for grabbing the at least one napkin, wherein the clamp pairs are of movable design in order to reach into the at least one hanging napkin. One preferred exemplary embodiment can provide for the clamp pairs to be formed by two cylinders that can be moved parallel to one another and are aligned parallel to one another. By virtue of the special embodiment of the gripping elements, these can be moved laterally into or up to the halves of the napkin or stack of napkins hanging freely from the beam and, by closure of the clamp jaws, can grab the napkins. Subsequently, the robot arm raises the gripping elements together with the grabbed napkins in order to redeposit them on the transport means. It is likewise conceivable for the gripping elements to be pivoted into the downwardly open U shape of the napkins hanging from the beam in order in this way to grab and transfer the napkins. Another exemplary embodiment can provide for the gripping elements to be designed in such a way that the napkins can be grabbed directly from the beam from above and pulled off downward.

Another advantageous exemplary embodiment of the invention can provide for the gripping elements to be designed as handling means in order to grab and transfer a beam together with at least one napkin. In this preferred exemplary embodiment, the beams are mounted releasably in the deposition devices. It is conceivable for the individual beams to be placed by the two ends from above into a receptacle and to be removable upward likewise without any expenditure of force or the need to trigger a mechanism. In this exemplary embodiment, the handling means grabs the beam together with the individual napkin or the entire stack of napkins. The robot then deposits the napkins together with the beam horizontally on the transport device. It is conceivable for the robot arm with the handling means to pull the beam out of the open end of the hanging or now lying napkins and to reset it to the free position of the deposition device. It is likewise conceivable for a handling means to be released by the beam and for the robot to pull the beam out of the napkin stack on one side. In the following step, the robot would reset the beam to the free position of the deposition device. The handling of the napkins together with the beams enables the napkins to be deposited on the transport device in a particularly reliable and precise manner.

In particular, provision can be made for the handling means to be designed as clamps, clips, grippers, hooks, electromagnets or the like. Here, these various types of handling means are designed in such a way that they can selectively and reliably grab and re-release the two free ends of the beams, between which the napkins are located.

It is preferably furthermore conceivable for the clamp pairs or the handling means to be secured, preferably movably, on a holder on the robot, wherein this holder matches the length of the beams or corresponds to the length of the beams. This holder is suspended directly from the multi-axis robot. It is conceivable for this holder to have a linear axis in order to vary the spacing of the two clamp pairs or handling means in order to grab the napkins or beams.

Moreover, the invention can provide for a camera system or a sensor for determining the two collection points for the napkin or the beam to be assigned to the apparatus or the robot. Here, provision is made for a three-dimensional image of the napkins or of the beams to be obtained by means of the, in particular 3D, camera in order to obtain the preferred collection points, i.e. the points at which the collection points or the beam can be grabbed. It is likewise conceivable for a plurality of beams to be recorded by means of the camera system and for the gripping elements to be moved up to the beams on which most of the napkins are located. It is thereby possible, particularly when using a robot, to prioritize the collection of the napkin according to the location and size of the stack. It is thereby possible to reduce the dwell times of the robot or to avoid unnecessarily long movements, which take unnecessary time.

Another advantageous exemplary embodiment can provide for a control system to assign coordinates to the collection points on the napkin or on the beams, and for the gripping elements to move selectively to these coordinates. Particularly by using a robot, it is possible to adopt the determined positions or coordinates in a particularly precise and reproducible manner. Through the creation of a three-dimensional coordinate system, which may change with respect to time, the control system can determine an optimum sequence of grabbing and transferring the napkin to make the method particularly efficient in terms of time. In addition, it is conceivable for the apparatus to have corresponding sensors for this purpose in order to detect the beams or the ends of the beams. Since the precise dimensions of the multiplicity of beams are stored in the control system, one or just a few coordinates are generally sufficient to enable the robot to move precisely up to a multiplicity of beams.

Another advantageous exemplary embodiment of the invention can provide for the robot to be arranged on rails, wherein the rails are aligned parallel to the beams of the deposition device, and the robot can be moved on these rails from the beams to the transport means. For this movement, the robot or the rails have corresponding motors which move the robot precisely to the positions determined by the control device. Here, optimization always takes place between the distance which can be traveled by the robot arm and the distance which can be achieved by movement on the rail. The transport means, which can be, for example, a belt conveyor, can be situated parallel to the rails or at the end of the rails. It is conceivable for a plurality of transport means to be arranged both at the two ends of the rails and also parallel to the rails in order to perform sorting of various napkins or various recipients of the napkins.

Finally, it is also possible, by means of one exemplary embodiment, to provide for the deposition device to be assigned a plurality of robots, in particular for each of the mutually adjacent beams to be assigned a robot, and for each of the robots to be assigned a transport means. Through this use of a plurality of robots, it is possible to further increase the cycle rate of the moving napkin. It is conceivable that each robot is assigned to just one drum of beams. However, it is likewise also possible that when a robot is idle, it accesses an adjacent beam drum.

A method for solving the problem stated at the outset comprises the features of claim 11. According to this, it is envisaged that a napkin, preferably a multiplicity of napkins, hangs in each case over one of a number of mutually adjacent beams of a deposition device, in particular in such a way that the napkin is deposited by means of a central region, preferably a center, over a beam. One significant measure consists in that the at least one napkin is grabbed in a fully automated and selective manner by two gripping elements arranged on a multi-axis robot and is deposited on a transport means.

Provision is furthermore preferably made for the gripping elements each to have a clamp pair, by means of which the at least one napkin is grabbed and transferred, or for the gripping elements to be designed as handling means, by means of which a beam together with at least one napkin is grabbed and transferred.

In particular, it is conceivable for two collection points on the napkin or the beam, up to which the clamp pairs or the handling means are moved in order to transfer the napkins or the beam, to be determined by a camera system or a sensor.

According to the invention, provision can furthermore be made for a control system to determine two collection points on the napkin or to assign the beam spatial coordinates up to which the gripping elements are moved to grab the napkin or the beam.

It is furthermore advantageously conceivable that the robot is moved on rails between the deposition device and the transport means in order to grab and deposit individual napkins or beams together with napkins.

Finally, it is conceivable that the napkins or the beams are grabbed from the deposition device by a plurality of robots and deposited on a plurality of transport means.

A preferred exemplary embodiment of the invention is explained in greater detail below by means of the drawing. In the drawing:

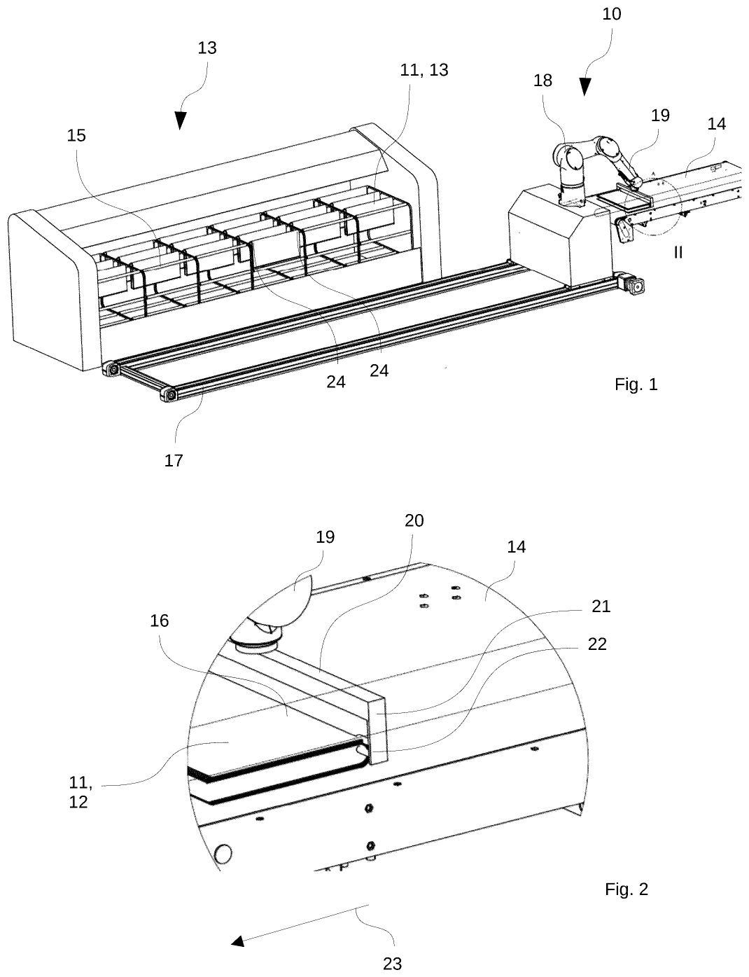

FIG. 1 shows an illustration of a first exemplary embodiment of an apparatus for handling napkins,

FIG. 2 shows an enlarged detail of the apparatus shown in FIG. 1,

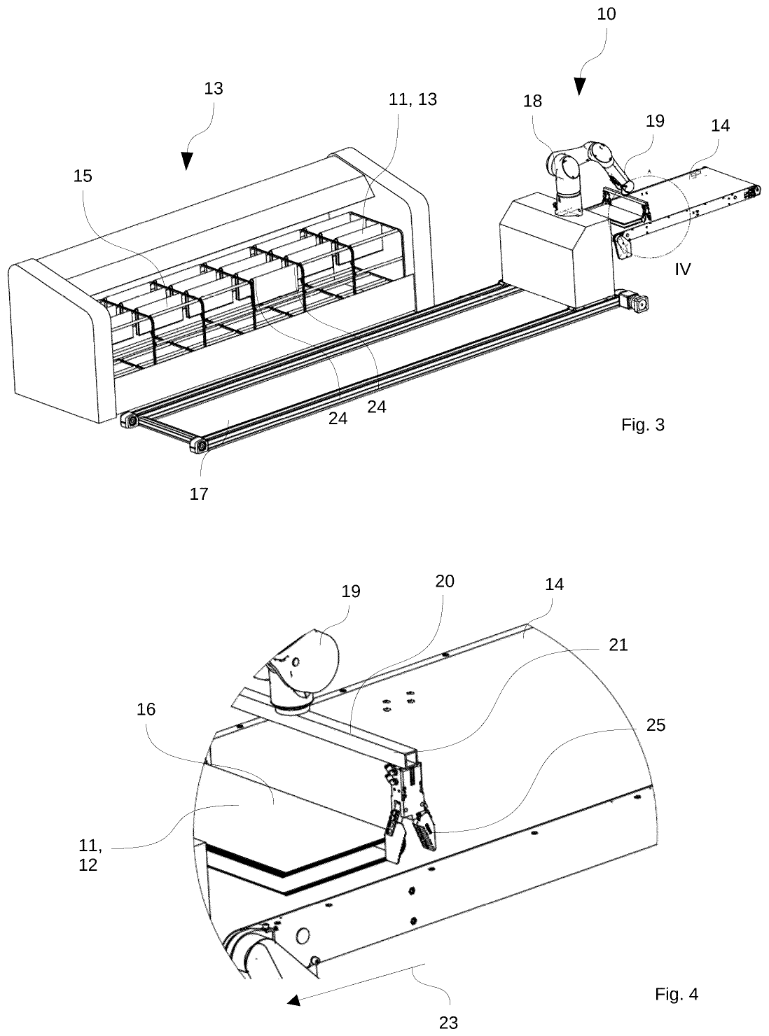

FIG. 3 shows an illustration of another exemplary embodiment of an apparatus for handling napkins,

FIG. 4 shows an enlarged detail of the apparatus shown in FIG. 3,

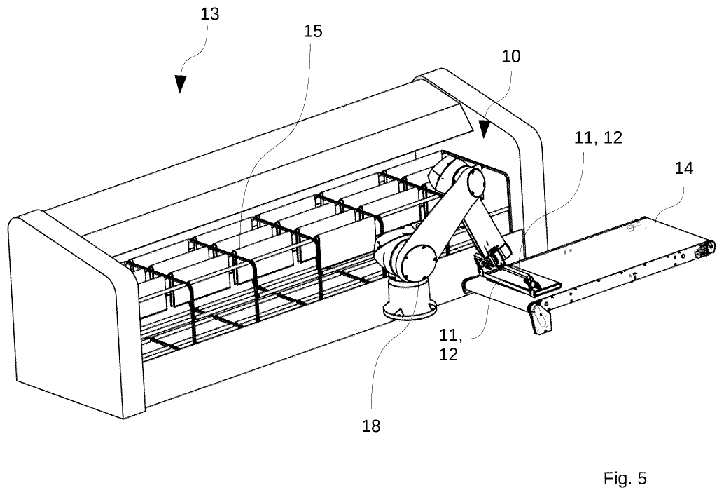

FIG. 5 shows an illustration of another exemplary embodiment of an apparatus for handling napkins, and

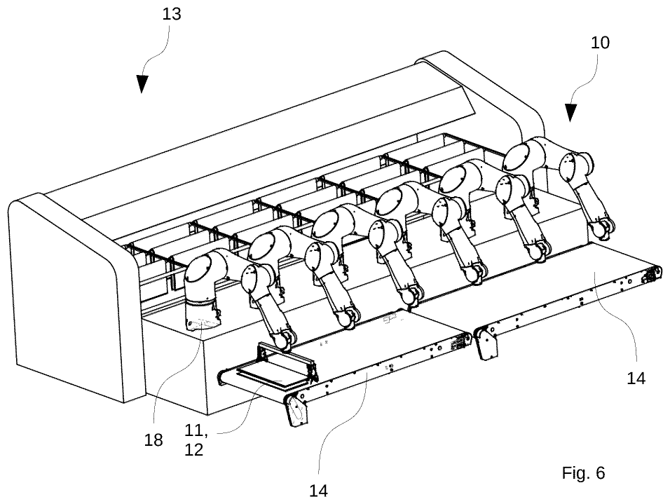

FIG. 6 shows an illustration of another exemplary embodiment of an apparatus for handling napkins.

FIG. 1 illustrates one possible exemplary embodiment of the apparatus 10. Essentially, the apparatus 10 is designed to deposit napkins 11 or stacks 12 of napkins 11 from a deposition device 13 onto a transport means 14 in a fully automated manner.

The washed and mangled napkins 11 are deposited manually or by machine over beams in the deposition device 13, more specifically in such a way that the individual napkins 11 rest by means of a central region 16 over the beam 15, such that two free halves of the napkins 11 hang down at least approximately congruently with respect to one another and thus form a downwardly open U. In general, a multiplicity of napkins 11 is deposited one on top of the other on the beam 15, with the result that a stack 12 is formed on the beam 15.

A multiplicity of beams 15 is arranged side-by-side, one behind the other and one on top of the other in the deposition device 13. It is conceivable that the beams 15 are integrated into a drum-type transport device, thus enabling the individual beams 15 to move within a track, e.g. a revolver drum. This enables beams 15 with a certain number of napkins 11 to be moved into a position from which they can be grabbed by the apparatus 10 for the next handling step. Likewise, empty beams 15 can be moved into a position in which they can be resupplied with napkins 11. The beams 15 have a length which corresponds at least to the width of the napkins 11. It is conceivable that a cross section of the beams 15 is round or polygonal.

The transport means 14 illustrated schematically here, can be designed as a belt conveyor, a continuous conveyor belt, chain conveyor or the like. The napkins 11 deposited there or the deposited stacks 12 are transported away for further processing. Further processing can comprise packing, for example.

In the exemplary embodiment illustrated in FIG. 1, there are rails 17 directly in front of the deposition device 13 and parallel to the transport means 14, on which rails the apparatus 10 can be moved parallel to the beams 15 but also parallel to the transport means 14. However, it should be expressly noted that this arrangement of the rails 17 is only illustrative and it is instead conceivable that other relative arrangements of the abovementioned components are also possible.

The apparatus 10 illustrated here has a multi-axis robot 18. A holder 20 is secured on a head end 19 of the robot 18. On this holder 20, in turn, there are gripping elements 21, which are designed to handle the napkins 11 selectively and in a fully automated manner. In the exemplary embodiment of the apparatus 10 which is illustrated in FIG. 1, the gripping elements 21 are designed as clamp pairs 22. These clamp pairs 22 each have a clamp jaw or two cylindrical clamp elements for grabbing the napkin 11 or the entire stack 12. The enlarged detail in FIG. 2 illustrates how a clamp pair 22 reaches into a stack 12 of napkins 11. On the other side of the napkin 11, an identical clamp pair 22 reaches into the stack 12 in the same way. From FIG. 2, it is apparent how the stack 12 of napkins 11 is deposited on the transport means 14, namely in such a way that the two previously free-hanging halves of the napkins 11 are deposited on one another. Subsequently, either the clamp pairs 22 are pulled out of the napkin stack 12 in direction 23, or the holder 20 is designed in such a way that the spacing between the clamp pairs 22 can be increased, such that the two clamp pairs 22 are moved outward and, as a result, release the stack 12.

To grab a stack 12 of napkins 11, the apparatus 10 is moved in the direction of the deposition device 13 into the vicinity of or in front of a beam 15. By means of a camera (not illustrated), e.g. a 3D camera or some other sensor means, a control device detects on which beam 15 there are napkins 11 and on which beam 15 there are no napkins 11. Depending on the number of napkins 11 hanging over a beam 15 and depending on the spacing of the holder 20 relative to a particular beam 15, the apparatus 10 or the robot 18 with the gripping element 21 is moved up to the corresponding beam 15. By means of the camera system or the sensors, two collection points 24 on the napkin 11 or the stack 12 are determined. This can be accomplished in a purely optical manner or by means of various types of sensor, e.g. distance sensors. The holder 20 with the gripping elements or clamp pairs 22 is then moved selectively and in a fully automatic manner up to these two collection points 24, and the napkins 11 are grabbed. In the next step, the napkins 11 or stack 12 are/is raised parallel to the beam 15, thus ensuring that the napkins 11 substantially retain their shape. It is conceivable here for the gripping elements 21 to exert a slight transverse force or tensioning force on the napkins 11. The apparatus 10 is then moved back in the direction of the transport means 14 in order to deposit the stack 12 as described above.

Another exemplary embodiment of the invention is described by FIGS. 3 and 4. While the method for handling the napkins 11 differs only slightly from the preceding exemplary embodiment described, the beam 15 in the second exemplary embodiment is arranged releasably in the deposition device 13. In this exemplary embodiment, the gripping elements 21 are designed as handling means 25. These handling means 25 can be clamps, clips, grippers, hooks, electromagnets or the like. These handling means 25 serve, at least not directly, to handle the napkins 11. On the contrary, the handling means 25 grab two ends of the beam 15 and move the beam 15, together with the napkins 11 or the stack 12, from the deposition device 13 to the transport means 14. In this exemplary embodiment too, collection points 24 are determined by a camera system or corresponding sensors. In this case, however, the collection points 24 are the ends of the beams 15. It is conceivable that these collection points 24 are clearly defined as coordinates in a fixed coordinate system of the apparatus 10 or the deposition device 13, making a camera system unnecessary for the detection of the collection points 24. However, a camera system could serve to determine the number of napkins 11 which have already been deposited over beams.

As soon as the napkins 11 have been deposited on the transport means 14, the beams 15 that have become free are guided back into the free position in the deposition device. It is conceivable here that a handling means 25 is released from one end of the beam 15, and the beam 15 is pulled laterally out of the stack. An alternative method step can provide for the beam to be pulled out of the stack 12 by the gripping element 21, or for the stack 12 to be transported away by the transport means 14 and thereby to move away from the beam 15.

In the exemplary embodiment illustrated in FIG. 5, the apparatus 10 is fixed at a fixed location in front of the deposition device 13. Here, the transport means 14 has been placed closer to the deposition device 13 in order to keep the paths short. In this exemplary embodiment, the multi-axis robot 18 is designed and positioned in such a way that it can reach each beam 15 of the deposition device 13 quickly and precisely. By dispensing with the rails 17, it is possible above all to save space. In addition, the complexity of the entire process can be reduced.

In FIG. 6, a robot 18 is arranged in front of each beam 15 or in front of each drum of beams 15. These robots 18, in turn, are assigned a plurality of transport means 14. By means of this multiplicity of robots 18, the napkins 11 can be moved particularly quickly from the beams 15 to the transport means 14. Depending on the type of napkin 11 or the recipient, the stacks 12 can be pre-sorted onto various transport means 14. It is conceivable that the robots access not only the beams 15 which are directly in front of them but also adjacent beams 15, provided these beams 15 are not currently being served by the corresponding robot 18 or the corresponding robot 18 is not currently performing some other movement. The control of these robots 18 is also coordinated by a control system, more specifically as a function of the positioning of the gripping elements 21 relative to the beams 15 or as a function of the state of the beams 15.

### LIST OF REFERENCE SIGNS

10 apparatus
11 napkin
12 stack
13 deposition device
14 transport means
15 beam
16 central region
17 rail
18 robot
19 head end
20 holder
21 gripping element
22 clamp pair
23 direction
24 collection point
25 handling means

1. An apparatus for handling napkins, wherein at least one napkin hangs in each case over one of a number of mutually adjacent beams of a deposition device, which apparatus comprises at least one multi-axis robot with two gripping elements, which can be moved selectively in a fully automated manner up to the at least one napkin and deposit the at least one napkin on a transport means.

2. The apparatus for handling napkins as claimed in claim 1, wherein the gripping elements each have a clamp pair for grabbing the at least one napkin, wherein the clamp pairs are of movable design in order to reach into the at least one hanging napkin.

3. The apparatus for handling napkins as claimed in claim 2, wherein the clamp pairs are formed by two cylinders that can be moved parallel to one another and are aligned parallel to one another.

4. The apparatus for handling napkins as claimed in claim 1, wherein the gripping elements are designed as handling means for grabbing and transferring a beam together with at least one napkin.

5. The apparatus for handling napkins as claimed in claim 4, wherein the handling means are designed as clamps, clips, grippers, hooks, electromagnets or the like.

6. The apparatus for handling napkins as claimed in claim 1, wherein the clamp pairs or the handling means are secured on a holder, wherein this holder matches the length of the beams or corresponds to the length of the beams.

7. The apparatus for handling napkins as claimed in claim 1, which comprises a camera system or a sensor for determining the two collection points for the napkin or the beam, up to which the clamp pairs or the handling means can be moved.

8. The apparatus for handling napkins as claimed in claim 1, which comprises a control system, which assigns coordinates to the collection points on the napkin or on the beams, and the gripping elements can be moved selectively to these coordinates.

9. The apparatus for handling napkins as claimed in claim 1, wherein the robot is arranged on rails, wherein the rails are aligned parallel to the beams of the deposition device, and the robot can be moved on the rails from the beams to the transport means.

10. The apparatus for handling napkins as claimed in claim 1, wherein the deposition device is assigned a plurality of robots, and each of the robots is assigned a transport means or one transport means.

11. A method for handling napkins, wherein at least one napkin hang in each case over one of a number of mutually adjacent beams of a deposition device, wherein the at least one napkin is grabbed in a fully automated and selective manner by two gripping elements arranged on a multi-axis robot and is deposited on a transport means.

12. The method for handling napkins as claimed in claim 11, wherein the gripping elements each have a clamp pair, by means of which the at least one napkin is grabbed and transferred, or wherein the gripping elements are designed as handling means, by means of which a beam together with at least one napkin is grabbed and transferred.

13. The method for handling napkins as claimed in claim 11, wherein two collection points on the napkin or the beam, up to which the clamp pairs or the handling means are moved in order to transfer the napkins or the beam, are determined by a camera system or a sensor.

14. The method for handling napkins as claimed in claim 11, wherein a control system assigns two collection points on the napkin or on the beam spatial coordinates up to which the gripping elements are moved to grab the napkin or the beam.

15. The method for handling napkins as claimed in claim 11, wherein the robot is moved on rails between the deposition device and the transport means in order to grab and deposit napkins or beams together with napkins.

16. The method for handling napkins as claimed in claim 11, wherein the napkins or the beams are grabbed from the deposition device by a plurality of robots and deposited on a plurality of transport means.
